(19) United States
(12) Patent Application Publication
(10) Pub. No.: US 2014/0279064 A1
(43) Pub. Date: Sep. 18, 2014

(54) PROGRAMMING AN ADVERTISING ENGINE

(71) Applicant: Radiate Media Holding Company, Salt Lake City, UT (US)

(72) Inventor: Corey Ercanbrack, Salt Lake City, UT (US)

(21) Appl. No.: 14/216,766

(22) Filed: Mar. 17, 2014

Related U.S. Application Data
(60) Provisional application No. 61/799,597, filed on Mar. 15, 2013.

(51) Int. Cl. G06Q 30/02

(52) U.S. Cl. CPC G06Q 30/0276
USPC 705/14.72

(57) ABSTRACT

An apparatus, system, and method are disclosed for programming an advertising configuration engine. In one embodiment, a method includes creating an advertising campaign for a client, the campaign advertising with one or more media services, the campaign based on a set of configuration parameters received from the client, updating client metadata with one or more social networks, and one or more directories, and promoting the client by allocating media resources to one or more of the media services.

### CROSS-REFERENCES TO RELATED APPLICATIONS

This application claims the benefit of U.S. Provisional Patent Application No. 61/799,597 entitled “ADVERTISING ANALYTICS TO PROGRAMMING A CONFIGURATION ENGINE” and filed on Mar. 15, 2013 for Corey Ercanbrack, which is incorporated herein by reference.

### FIELD

This invention relates to advertising and more particularly relates to programming an advertising engine.

### BACKGROUND

Technological advances have expanded advertising strategies and mediums. Advertising strategies may incorporate many different media services and may be very complex. Advertising may range from billboards, posters, mailings, emails, electronic messages, social media, online directories, search engines, etc. Managing many distinct media services may be too challenging for advertising entities.

Furthermore, different advertising strategies work better or worse for different products, demographics, geographical areas, industries, fields, etc. Therefore, successfully managing an advertising engine that encompasses these different areas may be extraordinarily complicated.

### SUMMARY

An apparatus for programming an advertising engine is disclosed. In one embodiment, the apparatus includes a user interface module that receives configuration parameters for an advertising campaign, a resource allocation module that allocates media resources to one or more media services, and an advertiser interface module that transmits media content to one or more of the media services. A system and method also perform the functions of the apparatus.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system in accordance with the present disclosure;

FIG. 2 is another schematic block diagram illustrating one embodiment of a system in accordance with the present disclosure;

FIG. 3 is a schematic block diagram illustrating one embodiment of a campaign manager module;

FIG. 4 is another schematic block diagram illustrating one embodiment of a campaign manager module;

FIG. 5 is a schematic block diagram illustrating one embodiment of a system in accordance with the present disclosure;

FIG. 6 is a schematic block diagram illustrating one embodiment of a system in accordance with the present disclosure;

FIG. 7 is a flow chart diagram illustrating one embodiment of a method in accordance with the present disclosure;

FIG. 8 is a flow chart diagram illustrating another embodiment of a method in accordance with the present disclosure;

FIG. 9 is an illustration depicting one embodiment of a user interface in accordance with the present disclosure;

FIG. 10 is an illustration depicting one embodiment of a user interface in accordance with the present disclosure;

FIG. 11 is an illustration depicting one embodiment of a user interface in accordance with the present disclosure;

FIG. 12 is an illustration depicting one embodiment of a user interface in accordance with the present disclosure;

FIG. 13 is an illustration depicting one embodiment of a user interface in accordance with the present disclosure;

FIG. 14 is an illustration depicting one embodiment of a user interface in accordance with the present disclosure;

FIG. 15 is an illustration depicting one embodiment of a user interface in accordance with the present disclosure;

FIG. 16 is an illustration depicting one embodiment of a user interface in accordance with the present disclosure; and

FIG. 17 is an illustration depicting one embodiment of a user interface in accordance with the present disclosure;

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing.

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In one embodiment of the present disclosure, a computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers. In one embodiment, a pay-as-you-go model may include various modules performing their respective functions based on available credit from a client. In response to insufficient credit from a client, the various modules may cease performing their respective functions. In response to additional credit being supplied by a client, the respective modules may continue performing as described herein. Therefore, the various modules may start, stop, pause, or the like, in response to available funds supplied by a client.

The computer program product may be integrated into a client, server and network environment by providing for the computer program product to coexist with applications, operating systems and network operating systems software and then installing the computer program product on the clients and servers in the environment where the computer program product will function.

In one embodiment software may be identified on the clients and servers including the network operating system where the computer program product will be deployed. In one embodiment, a deployed computer program product may include the network operating system that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As disclosed herein, various media services may be managed by a campaign manager module 150. In one embodiment, media services may include a wide variety of media, including, but not limited to, television broadcast media, radio broadcast media, digital media, print media, banner media, electronic media, online media, email media, text media, or other, or the like. Therefore, this disclosure is meant to include any and all media types.

In one embodiment, television broadcast media may be short form or long form. Short form may include commercials, advertisements, messages, or the like. Long form may include movies, television series, or the like. In another embodiment, the broadcast signal may include an analog or a digital signal. The broadcast signal may be interlaced, and may include hidden signals for encoding metadata. Hidden signals may include tele-text, closed captioning, or to indicate a format of the broadcast signal. In another embodiment, the television broadcast signal may be modulated. In one embodiment, the television broadcast signal may include many different standards, lines, frame rates, bandwidths, sound carrier separation frequency, sideband frequency, vision modulation, sound modulation, chrominance subcarrier frequency, vision/sound power ratio, usual color, or the like.

In another embodiment, a media service may include a radio broadcast signal. A radio broadcast signal may be from 30 kHz or lower, to 300 GHz or higher. A radio broadcast signal may be modulated, may be transmitted via a radio antenna, may use frequency-division multiplexing (FDM), may use frequency modulation (FM), may use amplitude modulation (AM), may include a subcarrier, may include single sideband voice, may include an analog signal, may include a digital signal, may include frequency-shift-keying. In one embodiment, the radio broadcast transmitter may be licensed or unlicensed.

In another embodiment, a media service may include a newspaper. A newspaper may include a periodical, news, current events, information, articles, other features, editorials, advertising, or the like. In another embodiment, a newspaper may include editorial opinions, criticism, persuasion, op-eds, obituaries, entertainment features, games, crosswords, Sudoku, horoscopes, weather, advice, food, review of other media services, reviews of movies, plays, restaurants, classified ads, display ads, radio and television listings, merchant inserts, editorial cartoons, gag cartoons, comic strips, or the like.

In another embodiment, a media service may include a business listing directory. A business listing directory may be printed or Internet based. A business listing or directory service may be categorized or organized in a variety of different ways, including, but not limited to, alphabetically, geographically, or the like.

In another embodiment, an internet business listing may be one of Google, Bing, Yahoo!, Yelp, Merchant Circle, LinkedIn, YellowPages.com, Whitepages, Supermedia, Yellowbook, CitySearch, Mapquest, Biznik, Local.com, Foursquare, ThinkLocal, CitySlick, USYellowPages, SuperPages, Outside.in, Dex, BizJournals.com, TeleAtlas, JustClickLocal, Discover our Town, Metrobot, MerchantCircle, EZ Local, twibs, LocalEze, Kudzu, CityVoter, Manta, Zipweb, MatchPoint, UsCity.net, Local Site Submit, InfoUSA, Axciom, Infignos, Yellow Assistance, Get Fave, My Huckleberry, GenieKnows, MojoPages, Brownbook, Magic Yellow, CitySquares, TeleAtlas, Navteq GPS, Judy's Book, or the like.

In another embodiment, a media service may be a sign or billboard. A billboard may be printed, or may be presented electronically via an electronic display, or the like. Billboards or signs may be placed in high traffic areas, and may include static images, physical objects, video, audio content, odors, or the like. In another embodiment, a billboard may spill beyond a default billboard space. In other embodiments, a billboard may be digital, inflatable, multi-purpose, may include many different advertisements displayed at different time intervals, may not be movable, may be movable, may spin, may move up and down, or the like.

In another embodiment, a media service may be an Internet web site. A web site may be a set of related web pages served from a single web domain, or from multiple web domains. A web site may be hosted on many different web servers, may be accessible via an Internet connection, may be available via a local network. In one embodiment, a web site may include plain text, HTML, XHTML, JavaScript, Ajax, C, C++, Python, BigTable, PHP, Erlang, JAVA, RoR, Scala, J2EE, Perl, WebSphere, Servlets, Cold Fusion, or the like.

In another embodiment, a web site may include content from another server, such as a database server, a content server, a media server, an advertising server, a database server, an RSS, or the like. A website database may include BigTable, MySQL, Microsoft SQL, PostgreSQL, Oracle, or the like. In another embodiment, a web site may be accessed via HTTP, HTTPS and may be access by a web browser, or a terminal, or the like. A website may be static or dynamic. A website may be dynamic based on a schedule, user input, other criteria.

In another embodiment, a media service may include search engine optimization (SEO). In one embodiment, SEO may include natural results where a search engine evolves based on clicked results from specific search terms. SEO may focus on image searches, local searches, video searches, academic searches, or the like. A search engine may learn preferred links depending on clicked links from a target audience (users of the search engine). A campaign manager module 150 may affect SEO may be affected by indicating web pages that may be crawled by an internet “spider.” A campaign manager module 150 may affect SEO by stuffing keywords and search terms in crawled pages, as one skilled in the art may appreciate.

In another embodiment, a media service may include search engine management (SEM). SEM may be similarly effected as SEO. In another embodiment, SEO may include paid submissions to guarantee crawling, set fees, or indicate a cost-per-click, or pay-per-click (PPC). Additionally, SEO may include human submissions, automated submissions, electronic messages, or the like.

In another embodiment, a media service may include social media. In one embodiment, social media may include internet forums, weblogs, social blogs, microblogs, wikis, social networks, podcasts, photographs, pictures, videos, ratings, social bookmarking, or other, or the like.

In one embodiment, social media may operate via a mobile device. Social media may be based on point in time, geographic location, emergency transmissions, slow transmission, or the like. Social media may include advertisements, sales promotions, discounts, coupons, relationship development, rewards programs, loyalty programs, or the like. In another embodiment, social media may include identification of users, followers, names, ages, genders, sexual orientation, conversations, tweets, blogs, posts, shared media, distributed media, presence of users, location or users, interest of users, hobbies of users, connection status of users, relationships between users, social networks, family, friends, fans, group admissions, reputation, ratings, feedback, or the like.

In another embodiment, a media service may focus on management of a reputation. Reputation management may include affecting search engines, SEO, or the like, in order to accentuate positive feedback, results, comments, or the minimize the effect of negative feedback, results, comments, ratings, or the like. In one embodiment, reputation management may include rewarding customers that have had a positive experience with an entity, although the reward, may or may not be directly correlated with the positive feedback. In another embodiment, reputation management may include forwarding positive feedback, comments, ratings, reviews to search engines so that they may more likely be found by potential future customers, or the like.

In one embodiment, reputation management may include affecting how web sites are crawled, or preventing Internet spiders from crawling sites that may include negative feedback. For example, an entity may provide web pages for receipt of negative comments, concerns, complains, problems, or the like, but may instruct an Internet spider to not crawl these web pages. Additionally, positive feedback pages may be crawled, and include in SEO algorithms, or the like. Where legal, reputation management may also include astroturfing third party review sites, censoring negative complaints, working with customers to change negative reviews, or the like.

In another embodiment, a media service may include email marketing, or SMS messages. Email marketing may include sending email messages to groups of people, cold lists, potential clients, customers, or the like. Emails may include advertisements, links to advertisements, business requests, solicit sales or donations, text, images, video content, audio content, attached media in a variety of formats, or the like. Emails may encourage customer loyalty, encourage repeat business, and seek initial business or new customers. Emails may be transactional emails, or direct emails.

SMS messages may also include similar content as email messages. In one embodiment, an SMS message may include images, text, audio, video, or the like. An SMS message may be sent to a short code, or a long numbers.

In another embodiment, a media service may include advertising during participation in a game or other online event. For example, in a massive multi-player online game (MMOG), promotional messages may be transmitted by players of the game. In this way, media content, or advertising content may be injected into an online event by participants. The participants may or may not be genuinely involved in the current event (e.g. they may just participate in order to advertise their products or services).

FIG. 1 is a schematic block diagram illustrating one embodiment of a system in accordance with the present disclosure. The system 100 includes a user 130, a campaign manager module 150, and a plurality of advertisers, 120. In one embodiment, a user 130 may communicate business information to a campaign manager module 150. The campaign manager module 150 may communicate advertisement to advertisers 120 based on information received from the user 130. The user may modify campaign parameters real-time, and the campaign manager module 150 may alter or effect media services or advertisers 120 based on updated or modified campaign parameters.

As described herein, an advertiser may be any type of entity that may operate a media service. An advertiser may advocate, encourage, persuade, or manipulate another entity to purchase a product or service. An advertiser may be a person, a computing system, an apparatus, or the like. An advertiser may employ a wide variety of media services, including, but not limited to wall paintings, billboards, street furniture or components, flyers, cards, radio, cinema, television, web banners, mobile screens, shopping carts, web popups, skywriting, benches, human billboards, forehead advertising, magazines, newspapers, town criers, sides of buses, banners, sides of airplanes, doors, roofs, tables, screens, stage shows, elastic bands, disposable devices, stickers, streaming media, streaming audio, streaming video, posters, event tickets, supermarket receipts, or anywhere else. Communication with an advertiser may be verbally, electronically, via print, or the like.

In one embodiment, a campaign manager module 150 may create media content for use by a media service. A campaign manager module 150 may create a storefront website using program code executable by a processor on a computing device. The web site may present information, imagery, audio, video, or other media content to represent an entity and what they want to promote or advertise. A storefront website may include a web site as previously described. A storefront website may include various designs, color schemes, logos, trademarks, maps, directions, information, widgets, tools, promotions, or the like.

A campaign manager module 150 may receive configuration parameters that indicate media services to be used for a campaign. The configuration parameters may indicate a schedule when to use certain media services. The configuration parameters may indicate a frequency of use for a media service. In certain embodiments, the configuration parameters may indicate a wide variety of different properties or characteristics of an advertising campaign as one skilled in the art may appreciate.

In one embodiment, the campaign manager module 150 may display SEO tools, ecommerce, a mobile interface, a dashboard, or the like. A dashboard may display traffic information for the web site including users, hits, page views, locations of users, Internet protocol (IP) addresses, form entries, or the like. A dashboard may also include social media content. For example, a dashboard may display social reach of a media service, Facebook posts, twitter tweets, or the like. A dashboard may also include results of SEO strategies, SEO status, keywords, trends, patterns, or the like. A dashboard may also display reach associated with a media service, or associated with media services currently being used. Reach may include many ad impressions, clicks, online visits, mobile visits, mobile inquiries, radio listeners, radio responses, or the like.

A campaign manager module 150 may display key traffic analytics. Traffic analytics may be used to measure or estimate the effectiveness of a media service. For example, web site traffic may be measure and correlated with advertisement via different media services. The traffic may be analyzed, as one skilled in the art may appreciate, to include location information, number of page hits, number of pages, or the like. Traffic may be measured at a local web site, or at an online web site. In another embodiment, the campaign manager module 150 may monitor comments, posts, blogs, or the like, communication about an entity. Therefore, regardless of the presence of a local web site, traffic analytics may measure effectiveness of a media service by measuring Internet traffic, or the like. Traffic analytics may also include recorded traffic analysis that may be replayed. Replayed traffic analytics may also indicate heat maps or other graphical representation of analyzed traffic.

Traffic analytics may also include web server log files, page tagging, geolocation of visitors, click analytics, customer lifecycle analytics, or the like, as one skilled in the art may appreciate. Potential customer click patterns, length of visit to web page may also indicate an effectiveness of a web site. Therefore, in certain embodiments, the campaign manager module 150 may determine that one web site is more effective than another at capturing visitors and/or increasing sales/profits.

A campaign manager module 150 may also provide a web client to help manage the variety of web services and capabilities described herein. For example, a set of web pages may be provided to assist a user of the web pages to create, cancel, generate, modify, schedule, delete, organize, measure, or monitor, a media service. Changes or modification via a web client, may be applied with a short time period, a few hours or faster, for example. In this example, a media service may be stopped, started, rescheduled, or the like by a user of the web client almost immediately.

In another embodiment, a campaign manager module 150 may market hyper-locally. Marketing hyper-locally may include focusing or isolating a specific media service to a small community or local physical area. Community mechanisms, interactions, cultures, religions, demographics, behaviors, trends, or the like, may be considered in order to provide a more effective local media service. In one example, a media service may consider GPS information at a mobile device in order to decide which advertisement or services to offer at a mobile device. In one example, a product or service may be more successful among a certain religious group. Therefore, in one embodiment, the campaign manager module 150 may focus an advertising campaign on a locale that may include a higher percentage of members of the religion. Of course, one skilled in the art may appreciate other ways to focus an advertising campaign on specific groups of peoples, or the like.

In another embodiment, hyper-local may include temporal location as well as physical location. A campaign manager module 150 may consider a time frame for an event in order to decide which advertisement to run via which media services. For example, a campaign manager module 150 may schedule certain advertisements via certain media services based on a popular sporting event, cultural event, holiday, day-time, night-time, evening, morning, weekdays, weekends, religious observance times, or the like. In one example, the campaign manager module 150 may determine that an upcoming football game could be a good platform for media advertising. Therefore, the campaign manager module 150 may target certain advertising media during a time when the football may be broadcast.

In another embodiment, a campaign manager module 150 may provide a centralized control interface for a user. In one embodiment, a campaign manager module 150 may provide a single user interface to control, effect, manipulate, alter, schedule, cancel, begin, or other, a plurality of media services, as previously described.

In one embodiment, a campaign manager module 150 may receive payment via electronic fund transfers, credit cards, checks, or other, or the like. Compensation for media services may be received on a specific schedule, such as monthly, yearly, weekly, or the like.

In another embodiment, as previously described, compensation may be received at other times. In one example, the campaign manager module 150 may advertise with media services in response to sufficient funds being available. In response to insufficient funds to pay for certain media services, the campaign manager module 150 may cease or pause advertising with one or more media services. The campaign manager module 150 may notify a client that funds are insufficient to advertise with one or more media services and the campaign manager module 150 may receive additional funds to continue advertising with the media service. Therefore, in certain embodiments, the campaign manager module 150 may advertise with one or more media services as long as funds are available.

In one embodiment, a campaign manager module 150 may allocate a form of logical currency to customers based on actual funds provided or paid. For example, a user may purchase credit, tokens, or the like. Tokens or credits may be used by a customer in order to allocate resources to specific media services. As used herein, resources may include financial funds, credits, tokens, checks, labor, or the like. In another embodiment, different media services may require different amount of tokens, at different times, at different locations, etc. Therefore, a user of a campaign manager module 150 may real-time alter a campaign by changing times of advertisements via different media services, starting new media services, canceling media services. A user's credit or tokens may be effected based on the altered schedule of advertisements. For example, if a user schedule more advertisement for a certain media service, that media service may require more tokens to be allocated. In another example, if a user cancels a media service, tokens or credits may be refunded to the user. In this example, the refunded tokens or credits may be used to start or initiate other media services. The number of tokens required for a specific media service may be effected based on schedule, time of day, weekday, weekend, temporal consistency with an event, such as dances, concerts, special events, holidays, or the like. In one embodiment, an interface to a campaign manager module 150 may allow a user to adjust frequency of an advertisement via multiple media services via a single slider bar, graphical control, button, drop-down box, or the like.

In another embodiment, a campaign manager module 150 may allow a user to configure advertisements for a media service based on personal interests, personal hobbies, cultural areas, geographic locations, specific television programs, specific television program types, genres, radio programs, radio program types (religious, sports, gardening, news, music, or the like), channels, or the like.

In one embodiment, a campaign manager module 150 may store historical configuration for a user. A user may save a current configuration, may subsequently alter the configuration of the campaign. Based on results, analytics, metrics, of the campaign, a user may choose to revert back to a save configuration. For example, a set of configuration parameters may be loaded, the changes applied, and the required amount of tokens or credits automatically deducted from the users account. This may allow a user to see real-time how his/her campaign choices effect his/her available resources.

In one embodiment, a campaign manager module 150 may include derived intelligence. Derived intelligence, as described herein, includes recommend settings, configuration, media services, schedules, or the like, based on historical success of like businesses. For example, a campaign manager module 150 may learn that certain advertisers 120 are very effective at advertising pizza parlors at a given geographic location. The campaign manager module 150 may not be aware of why the advertiser is especially successful at pizza parlors at the geographic location, but may nonetheless recommend settings consistent with what has previously been successful. Therefore, the campaign manager module 150 may derive intelligence from historical analytics, and recommend intelligent settings to a user 130 based on the historical success.

In one embodiment, a campaign manager module 150 may publish consistent information to available business directory listings. A user may alter business information such as, but not limited to, contact information, phone numbers, addresses, employees, business leadership, hours of operation, or the like. The information may be altered via a single user interface with a campaign manager module 150. The configuration manager module may automatically publish the altered information to available business directory listings previously described. This may allow a user, via a single interface, to update hundreds, or more, business listings with his/her contact information, or the like. Consistently updating many business directory listings via a single user interface may also ensure that information regarding the business is consistent across many listings.

In another embodiment, a campaign manager module 150 may recommend sets of configuration parameters to a user. For example, based on success of like businesses, a campaign manager module 150 may recommend a likely successful configuration of media services for a specific region, based on historical success, or the like. Therefore, in certain embodiments, the campaign manager module 150 may recommend sets of configuration parameters that have shown to be successful for a given demographic, geographic area, locale, religion, industry, any combination of the foregoing, or the like as previously described.

In one embodiment, the campaign manager module 150 may learn effectiveness of media services. The campaign manager module 150 may track effectiveness of an advertiser 120, and update preferences or recommended configuration parameters based on current effectiveness of advertisers 120. In another embodiment, the effectiveness of an advertiser may change over time. The campaign manager module 150 may monitor effectiveness of an advertiser 120 and may periodically update preferences or recommended configuration parameters for a campaign based on currently successful parameters. This may allow a user to be informed regarding trending patterns in advertising, based on current success, without having to track the success of the marketing.

In one example, a previously successful or effective advertiser 120b, may begin to indicate poor results. For example, advertising through the advertiser 120b may not result in any increase in sales. The campaign manager module 150 may suggest to a user 130 that a different advertiser 120c (or associated media services) may be more effective. The user 130 may alter his/her campaign via a user interface in order to quickly divert advertising resources to a more effective advertiser 120c (and/or associated media services). In another example, a previously unsuccessful advertiser 120a, may begin to be more effective. The campaign manager module 150 may suggest to a user 130 that the advertiser 120a, is becoming very effective. The user 130 may adjust campaign resources in order to direct more advertising resources to the more successful advertiser 120a.

In one embodiment, the campaign manager module 150 may create advertisement automatically. Based on current slogans, trademarks, colors, products, services, templates, preferences, or the like, a campaign manager module 150 may generate an advertisement for the user 130. In another embodiment, the campaign manager module 150 may transmit user metadata to a partner, where the partner may generate an advertisement from the provided information. The campaign manager module 150 may make suggestions based on a generated advertisement from a partner. The user 130 may approve of the generated advertisement, and the advertisement may be transmitted to several advertisers 120 for distribution.

In another embodiment, a campaign manager module 150 may receive currently existing advertisements. The campaign manager module 150 may digitize received advertisements. The advertisements may be in printed form, or other hardcopy. The campaign manager module 150 may scan, alter, manipulate, or other allow a user to do the same via a user interface. This may allow a user 130 with physical forms of advertisements, to quickly transition to an online, digital arena, with little effort.

In another embodiment, a campaign manager module 150 may alert a user 130 based on an increasing amount of negative review, feedback, comments, or the like. The campaign manager module 150 may attempt to mitigate the review based on the reputation management previously described. In another embodiment, the campaign manager module 150 may receive alerts from a partner product, or receive an aggregated reputation from a partner product. The user 130 may adjust media services, adjust advertisements, or the like, in order to address a growing negative sentiment toward the user 130. Therefore, a campaign manager module 150 may allow a user to more quickly address reputation problems. This is especially the case, when a single interface may be used to immediately effect a plurality of advertisers 120.

In one embodiment of a method, a business 130 may attend a workshop and may provide business information, logos, trademarks, contact information, industry information, or the like. The business 130 may create a web site via the campaign manager module 150, via a third party, via a partner, or the like. The campaign manager module 150 may review the information for consistency, and provide recommendations about slogans, colors, names, etc. The campaign manager module 150 may also receive recommendations for a third party, a partner, or the like. The campaign manager module 150 may publish the business information to business directory services as previously described, or may contract with a directory service to publish business information to multiple directories. The campaign manager module 150 may publish or launch a web site for the business 130, or provide a published web site, or set of web pages to be launched by a partner, hosting service, or the like. The campaign manager module 150 may publish generated keywords, search terms, or the like, with Internet search engines. The campaign manager module 150 may track keywords and search terms to verify effectiveness. The campaign manager module 150 may connect the business to a plurality of social networks, and may create accounts if necessary. The campaign manager module 150 may analyze traffic and perform analytics, review recent posts, recommend media resource allocations, create ads, select targeted demographics, geography, city, radio times, radio stations, television stations, television station types. In another embodiment, a campaign manager module 150 may disqualify or avoid certain media services based on preferences by the business 130, reputation, perception, or the like. The campaign manager module 150 may receive a schedule of advertisement based on the aforementioned factors. The business 150 may verify that generated ads, schedules, media services, are OK or appropriate. The campaign manager module 150 may execute the campaign strategy, run ads on schedule, may notify media services of start/stop dates/times. After a campaign runs for some time, as previously described, a campaign manager module 150 may monitor traffic, and recommend alterations to the campaign strategy based on traffic, historical success, marketing trends, trends of advertisers 120, or the like.

In another embodiment, the campaign manager module 150 may provide an easy selection interface for the business 130. For example, a campaign manager module 150 may provide an aggressive campaign strategy, an average campaign strategy, or a minimal campaign strategy. In this example, the business 130 may simply select one of three campaign strategies, and not be required to manage more detailed information. This may provide a business 130 with a simple single choice selection to run a complicated and integrated advertisement campaign. The campaign manager module 150 may also provide success metrics in a simplified format. For example, the campaign manager module 150 may generate a bar chart of the most successful media services or advertisers 120. This may allow a business 130 easy easily select a few of the most efficient advertisers 120 without having to analyze metrics, values, numbers, or the like.

FIG. 2 is another schematic block diagram illustrating one embodiment of a system in accordance with the present disclosure. In one embodiment, a user may provide business information to a campaign manager module 150. A campaign manager module 150 may generate multiple advertisements and transmit a portion of the advertisements to advertiser 120a, and a portion of advertisements to advertiser 120b. A results module 202 may monitor and track results of the advertisers 120, and may provide feedback to the campaign manager module 150. In another embodiment, the results module 202 may receive results from many sources, and aggregate the results into a composite product. The aggregated results may be transmitted to the campaign manager module 150. The campaign manager module 150 may receive updated information from the user 130, based on the feedback from the results module 202, and alter the portions of advertisement to the advertisers 120.

In one example, feedback from the results module 202 may indicate that advertiser 120a is more successful than advertiser 120b. The user 130 may adjust the campaign strategy to shift the advertisements to advertiser 120a. This may help the user 130 be more effective in the advertisement campaign. In another embodiment, the advertisers 120 are immediately impacted based on their effectiveness. A poorly performing advertiser may lose business quickly, while a successful of effective advertiser may quickly receive additional advertising revenues. Therefore, a short flow of information between results of advertisers and decision regarding which advertisers to use, may motivate advertisers 120 to perform more effectively. This may also benefit a business 130 advertising through the campaign manager module 150.

FIG. 3 is a schematic block diagram illustrating one embodiment of a campaign manager module 150. In one embodiment, a campaign manager module 150 may include a user interface module 302, a resource allocation module 304, and an advertiser interface module 306. The user interface module 302 may or may not perform similar functions described relative to the campaign manager module 150. The resource allocation module 304 may or may not perform similar functions described relative to the campaign manager module 150. The advertiser interface module 306 may or may not perform similar functions described relative to the campaign manager module 150.

In one embodiment, the user interface module 302 may perform or manage user interfaces described in regard to the campaign manager module 150. Specific examples of user interfaces are further described relative to FIGS. 9 through 16. As previously described relative to a campaign manager module 150, a user interface module 302 may provide a web interface, a software application interface, a mobile interface, or the like. Various interfaces may provide centralized control of multiple media services or advertisers.

In another embodiment, a user interface module 302 may communicate with a user 130 to update or inform the user 130 regarding trending markets, advertiser 120 effectiveness, or the like. Communication to a user 130 may occur via email, text messages, Internet posts, or the like. Also, as previously described relative to the campaign manager module 150, the user interface module 302 may allow a user 130 to quickly divert resources to a more effective advertiser 120c. In one embodiment, the user interface module 302 may perform all of the user interfaces performed by the campaign manager module 150 described in previous embodiments.

In one embodiment, a campaign manager module 150 may include a resource allocation module 304. A resource allocation module 304 may allocate media resources to one or more media services. In another embodiment, the resource allocation module 304 may determine how to allocate media resources to media services or advertisers 120. In one embodiment, the user interface module 302 may command the resource allocation module 304 on how to allocate media resources. In another embodiment, a resource allocation module 304 may automatically allocate resources to media services or advertisers 120 based on received feedback from a results module 202. Therefore, a resource allocation module 304 may stop advertising with an advertiser 120 based on poor results, or may provide additional advertising resources to another advertiser 120 based on successful results. Successful results may include increase sales, web site visits, contracts, workload, that may be attributed to the advertising efforts, or the like.

In another embodiment, a resource allocation module 304 may alter allocation of media resources based on a schedule as previously described relative to a campaign manager module 150. In one embodiment, a resource allocation module 304 may alter allocation of media resources based on input from a user of the user interface module 302.

In one embodiment, a campaign manager module 150 may include an advertiser interface module 306. An advertiser interface module may command the resource allocation module 304 to alter allocation of media resources based on communication with one or more advertisers 120. For example, an advertiser may alter conditions or costs of advertising services. In response to unexpected alterations to advertising conditions, an advertiser interface module 306 may command the resource allocation module 304 to cancel advertising with an advertiser 120. In another embodiment, an advertiser 120 may stop operations. In response to an advertiser no longer accepting advertisements, an advertiser interface module 306 may command a resource allocation module 304 to allocate media resources to other advertisers 120, without receiving confirmation from a user. In another embodiment, a resource allocation module 304 may stop advertising with a no longer operating advertiser, and notify the user 130 via the user interface module 302.

In another embodiment, an advertiser 120 may lower prices for media services, or change other advertising conditions. In one example, the advertiser interface module 306 may command the resource allocation module 304 to transmit a higher portion of advertisement to the advertiser that has lowered a cost of advertising, without response from a user 130. In another example, the advertiser interface module 306 may command the user interface module 302 to notify the user 130 of the changed conditions of an advertiser, and may request feedback from the user 130 before commanding the resource allocation module to altering portions of media resources to advertisers 120.

FIG. 4 is another schematic block diagram illustrating one embodiment of a campaign manager module 150. In one embodiment, a campaign manager module 150 may include a reputation management module 402, a demographics module 404, a social networks module 406, a results module 202, a scheduling module 410, an advertisement creation module 412, a campaign comparison module 414, a directory management module 416, a history module 419, a special even module 420, a user metadata module 422.

In one embodiment, a campaign manager module 150 may include a reputation management module 402. A reputation management module 402 may or may not perform similar functions as the campaign manager module 150.

As previously described relative to a campaign manager module 150, a reputation management module 402 may transmit information to search engines, perform SEO, accentuate or enhance positive feedback, minimize negative feedback, promote or advertise positive comments, demote or hide negative comments, or the like. A reputation management module 402 may reward customers that answer a customer survey, or the like. Information from a reputation management module 402 may motivate a user to modify a campaign. In another embodiment, a reputation management module 402 may receive negative feedback and command user interface module to limit crawling of feedback information, comments, review, ratings, etc. for a period of time. A reputation management module 402 may also provide a review of past positive comments, feedback, ratings, reviews, etc. and promote the positive elements to search engines, web crawlers, or the like. The user may also modify a current campaign based on this kind of feedback.

In one embodiment, a campaign manager module 150 may include a demographics module 404. A demographics module may or may not perform similar functions as a campaign manager module 150. A demographics module 404 may track effectiveness of various advertising services, or media services based on demographics. Demographics may include gender, age, ethnicity, knowledge of languages, disabilities, mobility, home ownership, employment status, location, sexual orientation, financial status, or the like.

A demographics module 404 may analyze results information and provide success metrics for particular demographic groups. For example, pizza advertisements may be more successful in a college environment where younger people may be more inclined to purchase pizza. Of course, this is but one example, and this disclosure is not limited in this regard.

In another embodiment, a demographics module may recommend campaign parameters based on historical success with certain demographic groups. A demographics module may learn that certain slogans, language, phrasing, imagery, colors, topics, subjects, or the like, of advertisements may or may not be more or less effective when advertising to certain demographic groups. A demographics module may recommend settings or parameters to a user 130 via a user interface module 302 in response to a user 130 identifying a certain demographic group to target in an advertisement campaign.

In another embodiment, a campaign manager module 150 may include a social networks module 406. A social networks module 406 may or may not perform similar functions as the campaign manager module 150. A social network module 406 may perform all functions related to social network previously described relative to the campaign manager module 150.

In one embodiment, a social network module 406 may create profiles for a variety of social networks. Although this disclosure is meant to include all social network sites, or to be developed networking sites, a comprehensive list cannot be practically constructed here, therefore, this disclosure cannot be limited to the following list of social network web sites: Academia.edu, allobii, aSmallWorld, Athlinks, Bebo, BlackPlanet, Blogster, Buzznet, CafeMom, CouchSurfing, Elixio, eToro, Facebook, Faceparty, Filmow, Flixter, Flickr, Foursquare, Friendica, GamerDNA, Gather, Habbo, Hotlist, Lafango, lifeknot, LinkedIn, MeetIn, Mixi, MyLife, MyOpera, Myspace, Netlog, PartyFlock, Playfire, Plurk, Ryze, ScienceStage, Skoob, Tribe.net, Twitter, Vox, Xanga, Yammer, Yelp, Zoopa, or the like. Other social networking sites may include adult content, content in appropriate for some users, content inappropriate for some religious groups, or the like.

In another embodiment, a social networks module 406 may include monitoring posts via appropriate social network sites in order to notify the user 130 of trending patterns in advertising, or notify the user 130 of a potential reputation issue, or the like. In one embodiment, a social networks module 406 may provide metrics measuring posts about the user 130, positive posts, negative posts, neutral posts, likeability metrics, or the like. In response to receiving these metrics, a user may be motivated to modify a current campaign.

In another embodiment, a campaign manager module 150 may include a scheduling module 410. A scheduling module 410 may or may not perform similar functions as the campaign manager module 150. A social network module 406 may perform all functions related to scheduling previously described relative to the campaign manager module 150.

In one embodiment, a scheduling module 410 may alter a schedule of campaign resources, and may command a resource allocation module 304 based on a current schedule. A scheduling module may receive scheduling information from the user interface module 302. As previously described, a schedule may consider, timing of a sporting event, timing of a cultural event, holidays, day-time, night-time, evening, morning, weekdays, weekends, religious observance times, holy days, events, dances, concerts, special events, regular events, community meetings, community events, or the like.

In another embodiment, a scheduling module 410 may notify a user of a conflict of schedule. For example, scheduling rules for weekdays and holidays may not be consistent. Therefore a schedule advertisement on a holiday and a weekday may be inconsistent with each other. The scheduling module 410 may notify a user of a potential conflict. The scheduling module 410 may alter one or more schedule based on feedback form the user, or may automatically adjust or correct the potential scheduling conflict. A scheduling module 410 may also recommend schedules that have shown to be historically successful.

In another embodiment, a campaign manager module 150 may include an advertisement creation module 412. An advertisement creation module 412 may or may not perform similar functions as the campaign manager module 150. An advertisement creation module 412 may perform all functions related to advertisement creation previously described relative to the campaign manager module 150.

In one embodiment, an advertisement creation module 412 may create media content for a user 130. An advertisement creation module 412 may create a web site, web site pages, or web site animations. An advertisement creation module 412 may use templates for web site creation. An advertisement creation module 412 may present designs, color schemes to a user to gauge a user's preference. An advertisement creation module 412 may receive trademarks, maps, directions, business information to create the media content or advertisements. An advertisement creation module 412 may generate imagery, animations, audio media content, video media content, simple text, HTML, Perl, PHP, ColdFusion, and other technologies related to a web site as previously described. A generated web site may also include tools, widgets, selection boxes, buttons, or the like, in order to receive input from a user of the web site.

In another embodiment, a campaign manager module 150 may include a campaign comparison module 414. A campaign comparison module 414 may or may not perform similar functions as the campaign manager module 150.

In one embodiment, a campaign comparison module 414 may track or record estimated success of a current campaign. A campaign comparison module 414 may record a set of configuration parameters for the campaign. A campaign comparison module 414 may compare previous campaign configuration, and based on results from the results module 202, may provide feedback to the user 130 regarding which campaign configurations have been most successful. The campaign metrics may be based on campaigns focused on specific events, time frames, demographics, industries, industry categories, or the like. A campaign comparison module 414 may also recommend campaigns that have been successful for other users. Although the campaign comparison module 414 may not demonstrate why the campaigns are more successful, the campaign comparison module 414 may suggest to the user 130 certain campaign configuration based on historical success.

In another embodiment, a campaign manager module 150 may include a directory management module 416. A directory management module 416 may or may not perform similar functions as the campaign manager module 150. A directory management module 416 may perform all functions related to directories previously described relative to the campaign manager module 150.

In one embodiment, a directory management module 416 may publish relevant user 130 information to multiple directory listings as previously described. A directory management module 416 may also request records from multiple directory listings and update a directory listing, or other, if an inconsistency, or incorrect information is found.

For example, a directory listing may suffer a technical problem and lose listing information. A directory listing may recover from a backup, however the backup may not have accurate information regarding the user. A directory management module 416 may detect the inaccurate information and update the directory listing based on updated information. This may limit the amount of inaccurate information about a user 130 or a business 130. Consistent information in a variety of directory listings may help a user 130 generate more business because potential customers will more easily be able to contact the business and will be less likely provided inaccurate information.

In another embodiment, a campaign manager module 150 may include a history module 418. A history module 418 may or may not perform similar functions as the campaign manager module 150. A history module 418 may perform all functions related to directories previously described relative to historical information as the campaign manager module 150.

In one embodiment, the history module 418 may record campaign parameters and correlate campaign parameters with results from the results module 202. After a user modifies a campaign, or a campaign parameters, a history module 418 may generate a new record. Over time, a history module 418 may associate sets of campaign parameters with results from the results module. This may allow a user to identify sets of configuration parameters that have been most successful in the past. A history module 418 may also correlate sets of configuration parameters with events, holidays, or other time periods in order to provide a more accurate likelihood of success for a given set of configuration parameters for a given event. A history module 418 may also provide sets of configuration parameters that have been successful for other users 130. Therefore, over time, users of the campaign manager module 150 may receive notifications and recommendations of successful campaigns, and may apply like or similar sets of configuration parameters for their campaigns. In one embodiment, a history module may command a schedule module 410 to make modification based on historical success. In another embodiment, a history module 418 may provide a recommendation to a user 130.

In another embodiment, a campaign manager module 150 may include a special event module 420. A special event module 420 may or may not perform similar functions as the campaign manager module 150. A special event module 420 may perform all functions related to special events previously described relative to the campaign manager module 150.

In one embodiment, a special event module 420 may receive special events from a user, and may command a scheduling module 410 to alter an advertising schedule based on a special event. In another embodiment, the special event module 420 may request historical data from the history module 418 for past special events and consider historical data before recommending a schedule to the scheduling module 410. In another embodiment, the special event module 420 may recommend campaign configuration parameters to a user for a special event via the user interface module 302.

In one example, the special even module 420 may modify configuration parameters only temporarily. After the special even occurs, the special event module 420 may revert configuration parameters to parameters that may have been set before the temporary configuration parameters for the special event were applied.

In another embodiment, a campaign manager module 150 may include a user metadata module 422. A user metadata module 422 may or may not perform similar functions as the campaign manager module 150. A user metadata module 422 may perform all functions related to user information previously described relative to the campaign manager module 150.

In one embodiment, the user metadata module 422 may receive user information or metadata via the user interface module 302. In one embodiment, the user metadata module 422 may store the user information in a database, a flat file, or other storage, or the like. The user metadata module 422 may provide user data to the directory management module 416. The user metadata module 422 may provide user data to the user interface module 302 for modification. The user metadata module 422 may provide user information for the advertisement creation module 412 to include user metadata in an advertisement.

User metadata may also include an amount of credits, or tokens a user may currently allocate. For example, a user metadata module 422 may notify a scheduling module 410 that a user no longer has available campaign resources, and the scheduling module 410 may stop advertising with media services or advertisers 120. In another example, a user that has been out of credits, may purchase more credits. After a user has purchased more credits, a user metadata module may command a scheduling module 410 to continue scheduling advertisement with media services.

FIG. 5 is a schematic block diagram illustrating one embodiment of a system in accordance with the present disclosure. In this system 500 a user interface module 302, and the results module may operation outside the scope of a campaign manager module 150. Additionally, in one embodiment, a campaign manager module 150 may include an API layer 502, a service or library 504, a billing module 512, a directory API 514, a partner service API 506, an online ads API 508, a mobile ads API 510, a data collector 516, and a database 518. The system 500 may also include a data warehouse 520. A partner service API 506 may include an API to any type of advertiser that may communicate via an API.

In the depicted embodiment, the campaign manager module 150 includes an API layer. An API layer, as disclosed herein includes, a protocol intended to be used to allow a software application or a component of a software application to communicate with another software application or a component of another software application. In one embodiment, a user interface module 302 may programmatically communicate with a campaign manager module 150. For example, a user interface module 302 may receive user 130 input via a web page on a web server. A software component on the web server, may programmatically configure the campaign manager module 150 in order to organize and instantiate the required schedule, directories, advertisements, etc. for an advertisement campaign.

In one embodiment, the campaign manager module 150 includes a service or library 504. A service or library may communicate with other services or libraries via an API, such as, but not limited to a partner service API 506, an online ads API 508, a mobile ads API 510, or the like.

In one embodiment, a partner service API 506 may allow the campaign manager module 150 to communicate campaign configuration parameters to partnered media advertising services. Therefore, a user may still configure only one campaign, however the campaign may be programmatically transmitted to other advertising services without the user having to communicate with the partner services. A partner service may further communicate campaign parameters to other partner services, such as, but not limited to, web hosting, directories, social network, other media services, or the like.

In another embodiment, the service or library 504 may communicate with an online ads API 508. As previously described regarding the partner service API 506, a campaign manager module 150 may communicate with a provider of online advertisements via an online ads API 508. This kind of API 508, may allow a campaign manager module 150 to programmatically communicate advertisements, logos, slogans, images, videos, or the like, to media services that create, generate, disseminate online advertisements. Because of an API, a user need not configure, or be aware that certain advertisement are being transmitted to other advertising services. This may allow a user to take advantage of a variety of other services without the user needing to understand how the other services operate.

In another embodiment, the service or library 504 may communicate with a mobile ads API 510. As previously described regarding the partner service API 506, a campaign manager module 150 may communicate with a provider of mobile ads via a mobile ads API 510. This kind of API 510, may allow a campaign manager module 150 to programmatically communicate advertisements, logos, slogans, images, videos, or the like, to media services that create, generate, disseminate mobile advertisements. Because of an API, a user need not configure, or be aware that certain advertisement are being transmitted to other advertising services. This may allow a user to take advantage of a variety of other services without the user needing to understand how the other services operate, as previously described.

In another embodiment, the service or library 504 may communicate with a directory API 514. As previously described regarding the partner service API 506, a campaign manager module 150 may communicate with a provider of a business directory via a directory API 514. This kind of API 514, may allow a campaign manager module 150 to programmatically communicate business information, contact information, phone numbers, emails, hours of operation, maps, directions, or the like, to directory services that maintain business directories. Because of an API, a user need not configure, or be aware that certain information is being transmitted to other advertising services. This may allow a user to take advantage of a variety of business directories without the user needing to understand how the other services operate, as previously described.

In another embodiment, the campaign manager module 150 may include a billing module 512. A billing module 512 may communicate with the user interface module 302 to notify a user when a bill is due. In another embodiment, a billing module 512 may be configured to bill a client automatically. In another embodiment, a billing module 512, may automatically draft funds from an account of a user 130. In another embodiment, a billing module 512 may provide reduced bills based on loyalty, contracts, additional services, complaints, or the like. In another embodiment, a billing module 512 may not bill a user, but allow a user use of services with compensation.

In one embodiment, a campaign manager module 150 may include a database 518 for storing directory information, created advertisements, sets of configuration parameters, historical data, or the like. In another embodiment, any of the other modules defined herein may use the database 518 to store associated information.

In another embodiment, the system 500 includes a data warehouse 520. A data warehouse 520 may be physically located at a different location, may be a file server, may be a web server, may operation via Internet, or via a cloud. The data warehouse may also track and record traffic, reach, page hits, Internet posts, comments, feedback, and other relevant information regarding the user of the campaign manager module 150.

In another embodiment, the results module may read data from the data warehouse. In another embodiment, the results module 202 may data mine, or apply various data mining techniques to data residing in the data warehouse 520. The results module 202 may then provide results to the user interface module 302 as previously described.

FIG. 6 is a schematic block diagram illustrating one embodiment 600 of a system in accordance with the present disclosure. In one embodiment, a user interface module 302 may be divided into several other modules, such as a create interface module 602, a connect interface module 604, a promote interface module 606, and an advance interface module 608. In the depicted embodiment, a campaign manager module 150 may communicate with the other depicted modules for various reasons as described below.

A create interface module 602 may or may not be substantially similar to a user interface module 302. A create interface module 602 may interact with a user to help create a web presence (website). A create interface module 602 may assist a user to create a web site, web pages, mobile interfaces, advertisements, schedule advertisements, setup accounts with social networks, directories, or the like. A create interface module may receive from a user sets of configuration parameters.

A connect interface module 604 may or may not be substantially similar to a user interface module 302. A connect interface module 604 may help a user connect to their customers over social network, online directories, email, or the like. A connect interface module 604 may assist a user to establish a social networking presence, synchronize with business listings, begin building a reputation, establish search terms and keywords and begin establishing a digital presence with various search engines.

A promote interface module 606 may or may not be substantially similar to a user interface module 302. A promote interface module 606 may assist in the management of campaigns, automatically create ads, web ads, mobile ads, online ads, television ads, radio ads, or the like, and may provide an easy interface for a user to use in order to begin sending advertisement to media services. A promote interface 606 may also recommend coupons, discounts, special events, short-form broadcasts, or the like, to help promote the user or business in a specific area or time, as previously described.

A campaign manager module 150, based on information received from the various interfaces 602, 604, 606 begin transmitting advertisement or scheduling advertisements with media services, such as, but not limited to, directory services 610, partner services 612, online services 614, mobile services 616, or the like.

FIG. 7 is a flow chart diagram illustrating one embodiment of a method 700 in accordance with the present disclosure. In one embodiment, the method may begin and the campaign manager module 150 may create 702 an advertising campaign. The campaign manager module 150 may update 704 client metadata. The campaign manager module 150 may promote 706 the client by allocating media resources to one or more of the media services and the method may end.

In another embodiment, a media manager module 150 may create a comprehensive presence and campaign strategy for a plurality of advertising services. A media manager module 150 may connect the campaign to multiple social networks and multiple directories. A media manager module 150 may promote 706 the client, associated with the campaign, with the plurality of advertising services.

FIG. 8 is a flow chart diagram illustrating another embodiment of a method 800 in accordance with the present disclosure. In one embodiment, the method may begin and the campaign manager module 150 may create 802 an advertising campaign. The campaign manager module 150 may update 804 client metadata at one or more remote media services. The user interface module 302 may provide 806 a user interface for a user. The campaign manager module 150 may receive 808 media content from a client or a user. The campaign manager module 150 may promote 810 the client as described herein. The reputation management module 402 may monitor 812 feedback from one or more customers of the client. The campaign manager module 150 may notify 814 the client in response to receiving negative feedback. The results module 202 may track 816 results of the campaign. The campaign manager module 150 may recommend 818 configuration parameters to the client based on the results of the campaign. The user interface module 302 may receive 820 updated parameters from the client. The campaign manager module 150 may adjust the campaign based on the updated parameters and the method may end.

In another embodiments, the method begins and a media manager module 150 creates a comprehensive presence and campaign strategy for a plurality of advertising services. A media manager module 150 may connect the campaign to multiple social networks and multiple directories. A media manager module 150 may promote the client, associated with the campaign, with the plurality of advertising services. A results module 202 may track results of the campaign. A media manager module 150 may adjust the campaign based on the results of the campaign.

FIG. 9 is an illustration depicting one embodiment of a user interface in accordance with the present disclosure. In this depicted embodiment, a user interface module 302 presents an interface for a user to enter user metadata. The metadata may include a business name, a phone number, an address, a city, key search terms or keywords, industry categories, email address, websites, state, zip codes, or the like.

FIG. 10 is an illustration depicting one embodiment of a user interface in accordance with the present disclosure. In this depicted embodiment, a user interface module 302 presents a summary page for a plurality of business directories. In the depicted embodiment, the display may present a score, description, time, website, and overall status for multiple directory listings. This may allow a business owner 130 to see how his/her business is represented via the directory listings in one simple interface.

FIG. 11 is an illustration depicting one embodiment of a user interface in accordance with the present disclosure. In the depicted embodiment, an example interface for a user is demonstrated. In this example, a user may select and manipulate a variety of configuration parameters for the campaign, including, but not limited to, campaign name, ad group, radio spot, ad titles, additional ad text, location, URL's (universal resource locators), etc.

FIG. 12 is an illustration depicting one embodiment of a user interface in accordance with the present disclosure. In the depicted embodiment, an example interface is demonstrated. In this example, a user 130 may be shown top keywords associated with the user 130. In this example, various search engines are presented via different colors, and a chart is presented to indicate which search terms were most searched for with the associated search engines. A user 130 may be able to alter the display by adding or subtracting individual search engines.

FIG. 13 is an illustration depicting one embodiment of a user interface in accordance with the present disclosure. In the depicted embodiment, an example interface is demonstrated. In this example, a user 130 may be shown reach metrics associated with different advertisement strategies. For example, a chart may demonstrate a number of responses based on online advertisements, mobile advertisements, radio advertisements, or the like. A total number of responses may also be charted. Therefore, in one easy interface, a user may estimate how successful certain advertisements are succeeding, and may adjust campaign configuration parameters accordingly.

FIG. 14 is an illustration depicting one embodiment of a user interface in accordance with the present disclosure. In the depicted embodiment, an example interface is demonstrated. In this example, a user 130 may be shown impressions based on the different advertising services being implemented. In this example, a user may select a time period to see a count of impressions, such as, but not limited to, 7 days, 30 days, 90 days, or more. A chart may demonstrate the number of impressions and may color correlate them to individual media services, such as radio, Facebook, Twitter, Foursquare, LinkedIn, or the like. A user may additionally, select or deselect certain sources of impressions via the interface.

FIG. 15 is an illustration depicting one embodiment of a user interface in accordance with the present disclosure. In the depicted embodiment, an example interface is demonstrated. In this example, a user 130 may be shown a bar chart indicating a successful reach to a variety of social networks. A user may select or deselect social network to be charted, and may select different time periods to display. A secondary display may also indicate areas that may need attention. In this example, there are no directory listings for the current user. Therefore, the user interface may indicate to a user 130 regarding a deficiency, and the user 130 may be motivated to correct the deficiency.

Additionally, in this embodiment, a header may be displayed allowing a user to shift to other pages including a dashboard page, a web site page, a connection page (depicted in FIG. 15), and a promotions page.

FIG. 16 is an illustration depicting one embodiment of a user interface in accordance with the present disclosure. In the depicted embodiment, an example interface is demonstrated. In this example, a user 130 may be shown a chart estimating traffic for a campaign. In one embodiment, the display may indicate an amount of traffic from a variety of different sources. The interface may also indicate which traffic is from referral, and which traffic is organic. As disclosed herein, organic traffic is traffic generated that may not be associated with paid services. Organic traffic may be generated or increased by transmitting information to directories, search engines, guides, or the like.

FIG. 17 is an illustration depicting one embodiment of a user interface in accordance with the present disclosure. In the depicted embodiment, the user interface module 302 may construct or provide an advance analytics display. The user interface module 302 may aggregate success metrics from all available advertisers, and provide a composite display displaying web page visits, page views, pages per visit, bounce rates, connection counts, Facebook posts, Twitter tweets, Foursquare results, LinkedIn posts, total hits, total online references, click-throughs, or the like. These various metrics may be presented via a single chart include multiple axes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
creating an advertising campaign for a client, the campaign advertising with one or more media services, the campaign based on a set of configuration parameters received from the client;
updating client metadata with one or more social networks, and one or more directories; and
promoting the client by allocating media resources to one or more of the media services.

2. The method of claim 1, further comprising:
monitoring feedback from customers of the client; and
notifying the client in response to receiving negative feedback.

3. The method of claim 1, further comprising:
tracking advertising results of the campaign; and
adjusting the campaign based on results of the campaign.

4. The method of claim 1, further comprising:
receiving updated parameters from the client; and
adjusting the campaign based on the updated parameters.

5. The method of claim 4, wherein the updated parameters configure the campaign for a temporary event, the method further comprising reverting to previous parameters after the temporary event has occurred.

6. The method of claim 1, further comprising recommending configuration parameters to the client.

7. The method of claim 1, further comprising receiving media content from the client, and transmitting the media content to one or more of the advertising entities.

8. The method of claim 1, further comprising adjusting configuration parameters, without user intervention, in response to insufficient funds.

9. The method of claim 1, wherein one of the advertising entities is selected from the group consisting of a television broadcast, radio broadcast, web site, social media, business directory, mobile advertisement, Internet advertisement, search engine optimization, email advertisement, and an SMS advertisement.

10. The method of claim 9, wherein the promoting communicates with the one or more media services using an application programming interface (API).

11. The method of claim 1, further comprising providing a user interface to the client, the user interface configured to receive configuration parameters from the client and to display campaign results.

12. An apparatus comprising a campaign manager module, the campaign manager module comprising:
a user interface module that receives configuration parameters for an advertising campaign;
a resource allocation module that allocates media resources to one or more media services; and
an advertiser interface module that transmits media content to one or more of the media services,
wherein at least a portion of the user interface module, the resource allocation module, and the advertiser interface module comprise one or more of hardware and executable code, the executable code stored on one or more computer readable storage media.

13. The apparatus of claim 12, further comprising a module selected from the group consisting of a reputation management module, a demographics module, a social network module, a results module, a scheduling module, an advertisement creation module, a campaign comparison module, a directory module, a history module, a special event module, and a user metadata module.

14. The apparatus of claim 12, wherein the advertiser interface module communicates with the one or more media services via an application programming interface.

15. The apparatus of claim 12, wherein one of the media services is selected from the group consisting of a television broadcast, radio broadcast, web site, social media, business directory, mobile advertisement, Internet advertisement, search engine optimization, email advertisement, and an SMS advertisement.

16. A computer program product comprising a computer readable storage medium having program code embodied therein, the program code readable/executable by a processor for:
creating an advertising campaign for a client, the campaign advertising with one or more media services, the campaign based on a set of configuration parameters received from the client;
updating client metadata with one or more social networks, and one or more directories; and
promoting the client by allocating media resources to one or more of the media services.

17. The computer program product of claim 16, the program code further configured for:
monitoring feedback from customers of the client; and
notifying the client in response to receiving negative feedback.

18. The computer program product of claim 16, the program code further configured for:
tracking advertising results of the campaign; and
adjusting the campaign based on results of the campaign.

19. The computer program product of claim 16, the program code further configured for:
receiving updated parameters from the client; and
adjusting the campaign based on the updated parameters.

20. The computer program product of claim 16, further comprising recommending configuration parameters to the client.
